(19) United States
(12) Patent Application Publication
(10) Pub. No.: US 2018/0202220 A1
(43) Pub. Date: Jul. 19, 2018

(54) Cord Reel Device for a Window Blind

(71) Applicant: Taicang Kingfu Plastic Manufacture Co., Ltd., Taicang (CN)

(72) Inventor: Szu-Chang Huang, Fusing Township (TW)

(21) Appl. No.: 15/497,245

(22) Filed: Apr. 26, 2017

(30) Foreign Application Priority Data
Jan. 18, 2017 (CN) 201720060769.1
Jan. 25, 2017 (CN) 201720105190.2

(51) Int. Cl. E06B 9/322

(52) U.S. Cl. CPC E06B 9/322

(57) ABSTRACT

A cord reel device for retaining a pull cord of a window blind includes a casing unit, a reel unit and a retard unit. The casing unit defines a retaining space therein. The reel unit is disposed in the retaining space, and includes a reel wheel that is rotatable for reeling the pull cord, and a driving module that is connected to the reel wheel for driving rotation of the reel wheel. The retard unit includes at least three retarding pins that permit the pull cord to extend therearound for providing a retarding force to the pull cord.

### CROSS-REFERENCE TO RELATED APPLICATION

This application claims priorities of Chinese Patent Application No. 201720060769.1, filed on Jan. 18, 2017, and Chinese Patent Application No. 201720105190.2, filed on Jan. 25, 2017.

### FIELD

The disclosure relates to a reel device, and more particularly to a cord reel device for a window blind.

### BACKGROUND

A conventional window blind includes an exposed pull cord that is operable for adjusting a blind unit. However, the exposed pull cord may easily tangle, and may even present a strangulation hazard to children.

### SUMMARY

Therefore, an object of the disclosure is to provide a cord reel device that can alleviate at least one of the drawbacks of the prior art.

According to the disclosure, the cord reel device is for retaining a pull cord of a window blind, and includes a casing unit, a reel unit and a retard unit. The casing unit defines a retaining space therein. The reel unit is disposed in the retaining space, and includes a reel wheel that is rotatable for reeling the pull cord, and a driving module that is connected to the reel wheel for driving rotation of the reel wheel. The retard unit includes at least three retarding pins that permit the pull cord to extend therearound for providing a retarding force to the pull cord.

### BRIEF DESCRIPTION OF THE DRAWINGS

Other features and advantages of the disclosure will become apparent in the following detailed description of the embodiments with reference to the accompanying drawings, of which:

FIG. 1 is a perspective view illustrating a first embodiment of the cord reel device according to the disclosure;

FIG. 2 is an exploded perspective view illustrating the first embodiment;

FIG. 3 is a sectional view taken along line III-III in FIG. 1, illustrating the first embodiment;

FIG. 4 is a schematic sectional view taken along line IV-IV in FIG. 3, illustrating the first embodiment;

FIG. 5 is another schematic sectional view illustrating the first embodiment;

FIG. 6 is a schematic exploded perspective view illustrating the first embodiment being installed onto an upper rail of a window blind;

FIG. 7 is a schematic perspective view illustrating the first embodiment being installed onto the upper rail of the window blind;

FIG. 8 is an exploded perspective view illustrating a second embodiment of the cord reel device according to the disclosure; and

FIG. 9 is a sectional view illustrating the second embodiment.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

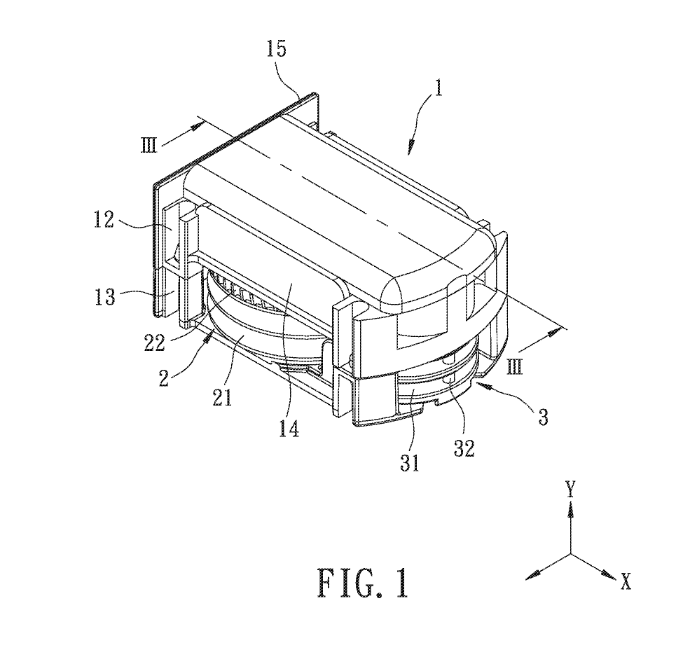

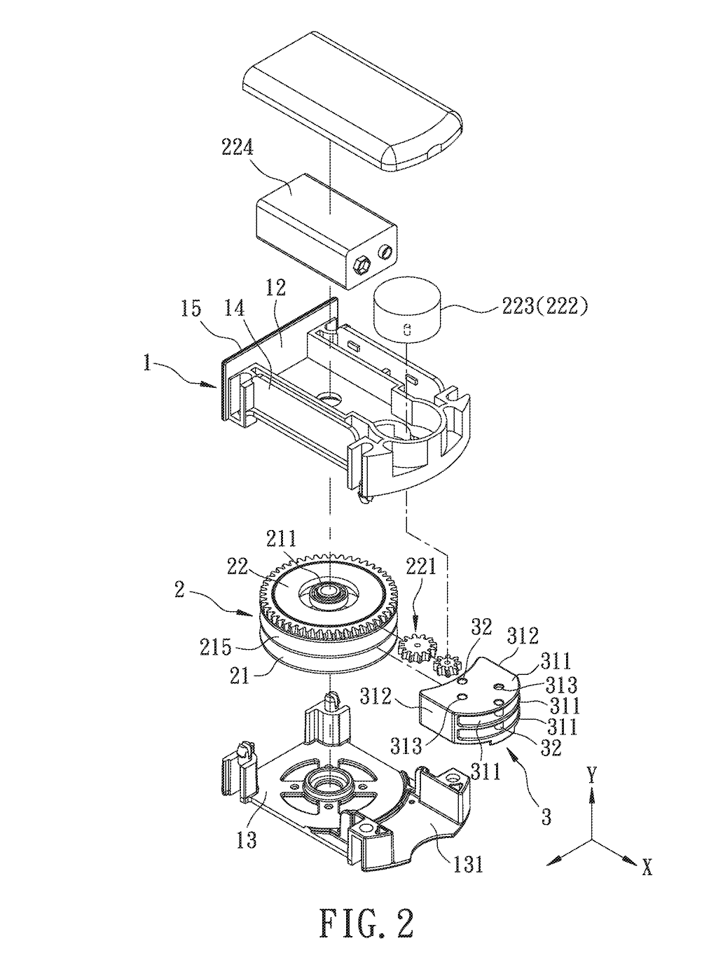

Referring to FIGS. 1 to 3, the first embodiment of the cord reel device according to the disclosure is for retaining and operating a pull cord 9 of a window blind (not shown), and includes a casing unit 1, a reel. unit 2 and a retard unit 3.

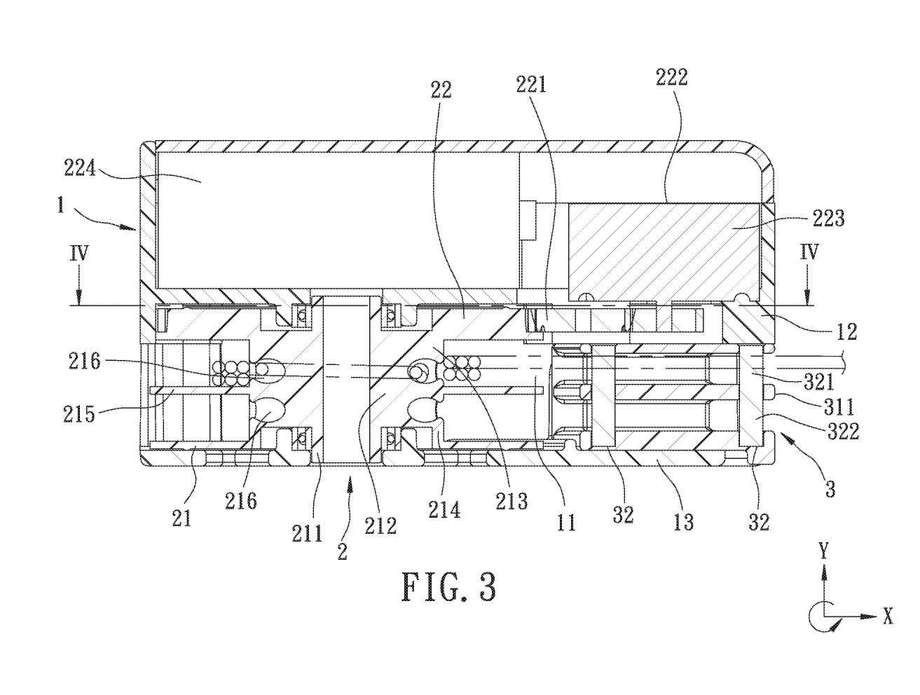

The casing unit 1 defines a retaining space 11 (see FIG. 3) therein. In this embodiment, the casing unit 1 includes a first casing body 12, and a second casing body 13 that is connected to the first casing body 12 and that cooperates with the first casing body 12 to define the retaining space 11. The second casing body 13 has an installation groove 131 that forms a portion of the retaining space 11 and that is for installation of the retard unit 3.

The reel unit 2 is disposed in the retaining space 11 of the casing unit 1, and includes a reel wheel 21 that is rotatable for reeling the pull cord. 9, and a driving module 22 that is connected to the reel wheel 21 for driving rotation of the reel wheel 21.

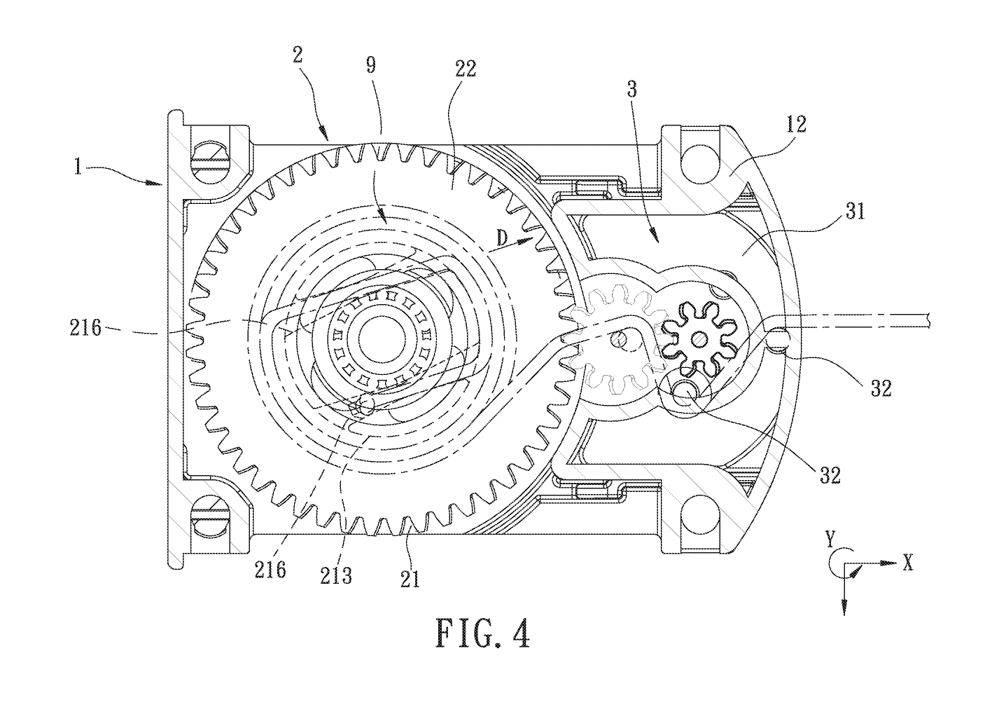

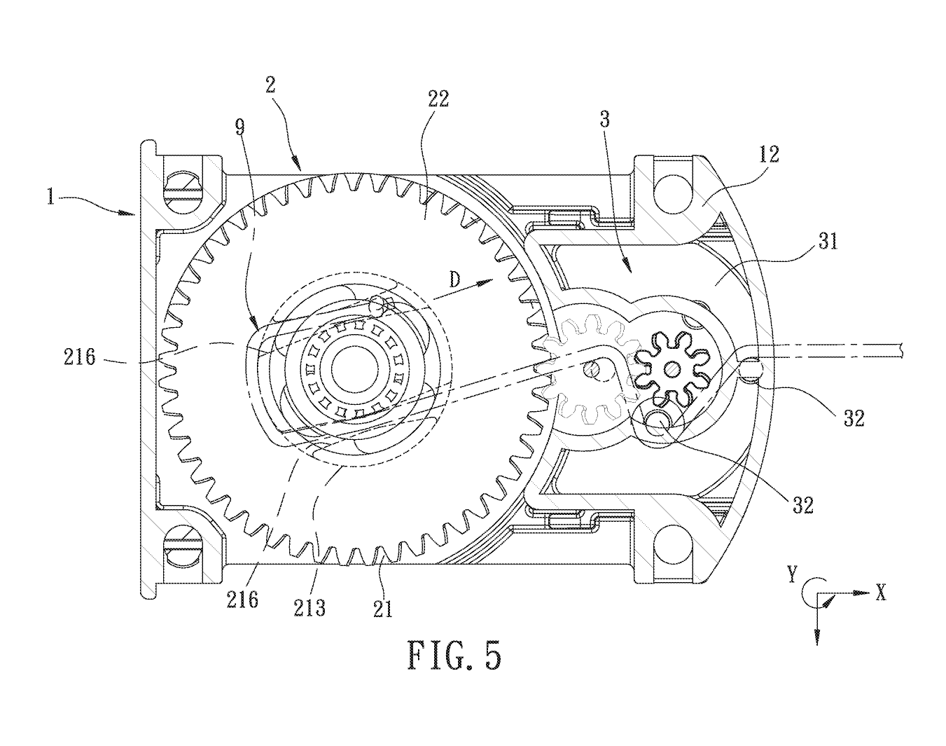

The reel wheel 21 is rotatably disposed in the retaining space 11 of the casing unit 1, and is rotatable about a rotating axis that extends in a first direction (Y). The reel wheel 21 has an axle portion 211 that extends in the first direction (Y), a reel portion 212 that surrounds the axle portion 211, a partition plate 215 that divides the reel portion 212 into a first reel region 213 and a second reel region 214, and two securing structures that are respectively disposed at the first and second reel regions 213, 214 for securing the pull cord 9 to the reel wheel 21. In this embodiment, each of the securing structures includes two spaced-apart through holes 216 that are formed through the corresponding one of the first and second reel regions 213, 214 and that substantially extend in an extending direction (D) (see FIGS. 4 and 5) perpendicular to the first direction (Y).

The driving module 22 includes a gear train 221 and an electric motor set 222. The electric motor set 222 includes an electric motor 223, and a battery 224 for supplying electric power to the electric motor 223. The gear train 221 is connected between the reel wheel 21 and an output shaft of the electric motor 223 for transmitting mechanical power from the electric motor 223 to the reel wheel 21. In this embodiment, the gear train 221 is disposed above the retard unit 3 and the reel wheel 21, and the electric motor 223 is disposed above the gear train 221.

The retard unit 3 is disposed in the casing unit 1 for providing a retarding force to the pull cord 9, and includes a base seat 31, and at least three retarding pins 32 that are mounted to the base seat 31.

In this embodiment, the base seat 31 is removably mounted in the installation groove 131, and includes three compartment plates 311 that are spaced apart from each other in the first direction (Y), and two side plates 312 that are respectively connected to two opposite sides of each of the compartment plates 311. Each of the compartment plates 311 is formed with a plurality of installation holes 313 that are respectively aligned with the installation holes 313 of another one of the compartment plates 311 in the first direction (Y). The side plates 312 of the base seat 31 are movable in a second direction (X) perpendicular to the first direction (Y) to be removably fitted into the installation groove 131.

Each of the retarding pins 32 is inserted into one of the installation holes 313 of one of the compartment plates 311 and the aligned installation holes 313 of the other compartment plates 311. The middle one of the compartment plates 311 is substantially aligned with the partition plate 215 of the reel wheel 21 in the second direction (X), and divides each of the retarding pins 32 into a first retarding section 321 and a second retarding section 322. The first and second retarding sections 321, 322 of each of the retarding pins 32 respectively correspond to the first and second reel regions 213, 214 of the reel wheel 21. As such, the cord reel device of this disclosure can retain at least two pull cords 9 therein.

Referring to FIGS. 3 to 5, the cord reel device is operable to wind or unwind the pull cord 9 so as to adjust a blind unit (not shown) of the window blind.

To secure the pull cord 9 to the reel wheel 21, the pull cord 9 first extends around one of the first and second retarding sections 321, 322 of each of the retarding pins 32, and then extends through the through holes 216 formed in the corresponding one of the first and second reel regions 213, 214 of the reel wheel 21 so as to be secured to the reel wheel 21 (see FIG. 5). Afterward, the electric motor 223 is supplied by the battery 224 to drive rotation of the reel wheel 21 via the gear train 221, so as to wind or unwind the pull cord 9 (see FIG. 4) for adjusting the blind unit.

It can be understood that the rotational direction of the output shaft of the electric motor 223 can be controlled by a control module (not shown). The control module may be configured to be button-controlled or remote-controlled. A user can adjust the blind unit via operation of the control module without touching the blind unit.

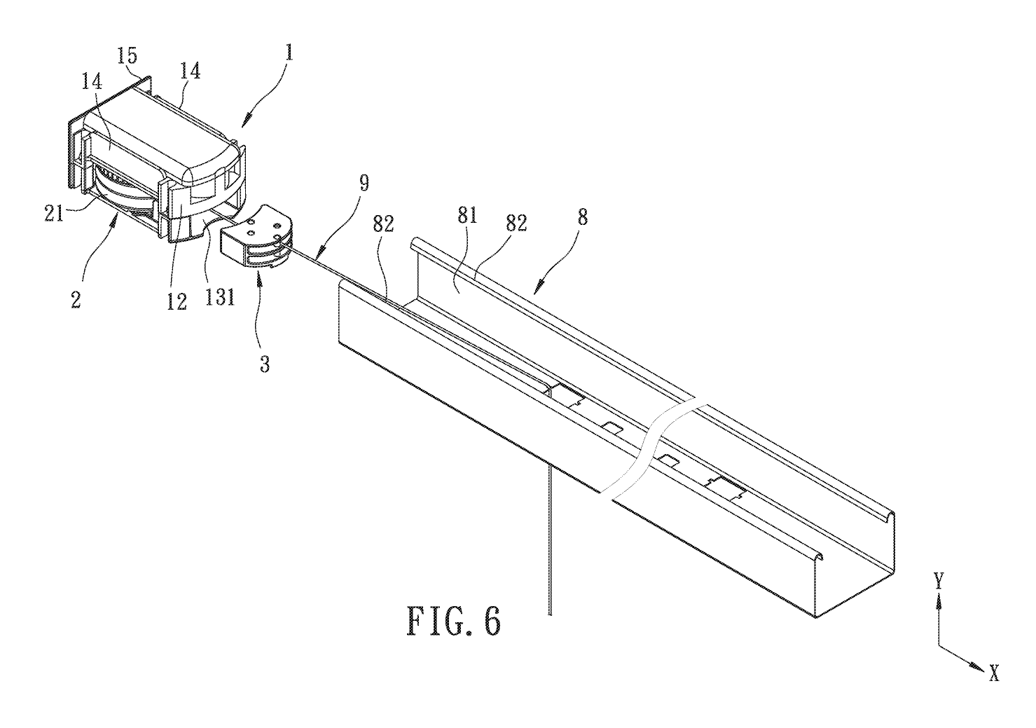

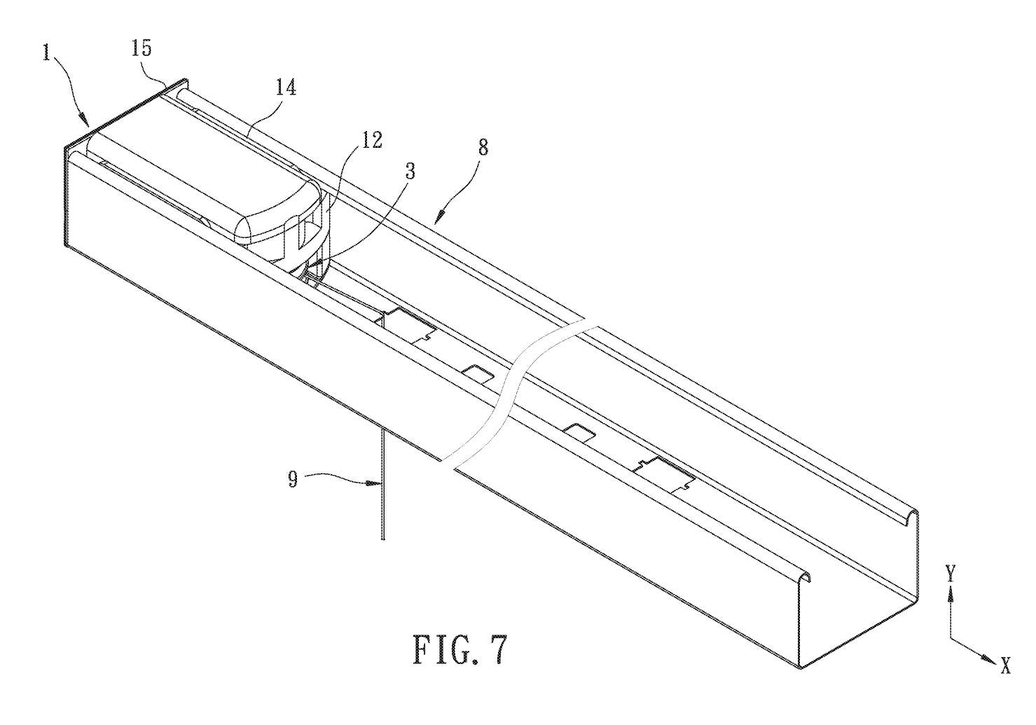

Referring to FIGS. 6 and 7, the cord reel device can be installed onto an upper rail 8 of the window blind. The pull cord 9 extends through the upper rail 8, and is exposed originally. The upper rail 8 has two spaced-apart side walls 82 that extend in the second direction (X), and that cooperatively define an installation space 81 therebetween. The casing unit 1 further has two lateral stop walls 14. During the installation of the cord reel device onto the upper rail 8, the retard unit 3 is first separated from the casing unit 1 so as to enable the pull cord 9 to extend around the retarding pins 32 of the retard unit 3 and to be secured to the reel wheel 21. After the pull cord 9 is secured to the reel wheel 21, the retard unit 3 is moved into the casing unit 1, and the cord reel device is moved in the second direction (X) into the installation space 81 of the upper rail 8, and retains the exposed portion of the pull cord 9.

It should be noted that the lateral stop walls 14 of the casing unit 1 respectively abut against the side walls 82 of the upper rail 8, so as to position the casing unit 1 steadily within the upper rail 8. The casing unit 1 further has an end stop wall 15 that is opposite to the installation groove 131 and that abuts against the side walls 82 of the upper rail 8 (see FIG. 7) so as to prevent the cord reel device from moving relative to the upper rail 8 when a portion of the pull cord 9 that is distal from the cord reel device is pulled fiercely.

Since the pull cord 9 is secured to the reel wheel 21, the weight of the blind unit pulls the cord reel device via the pull cord 9 such that the end stop wall 15 abuts against the side walls 82 so as to position the cord reel device relative to the upper rail 8. Moreover, since the lateral stop walls 14 of the casing unit 1 respectively abut against the side walls 82 of the upper rail 8, the cord reel device can be installed into the upper rail 8 rapidly without assistance of additional tools.

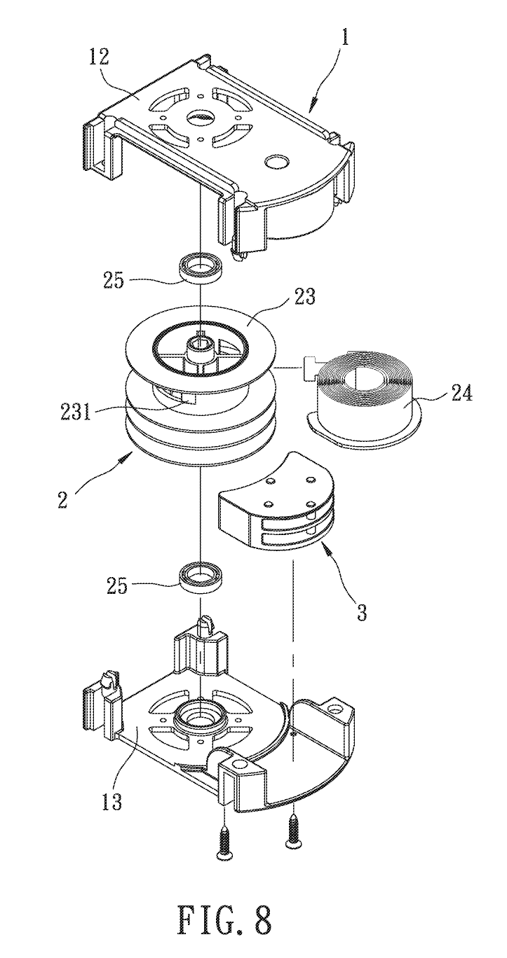

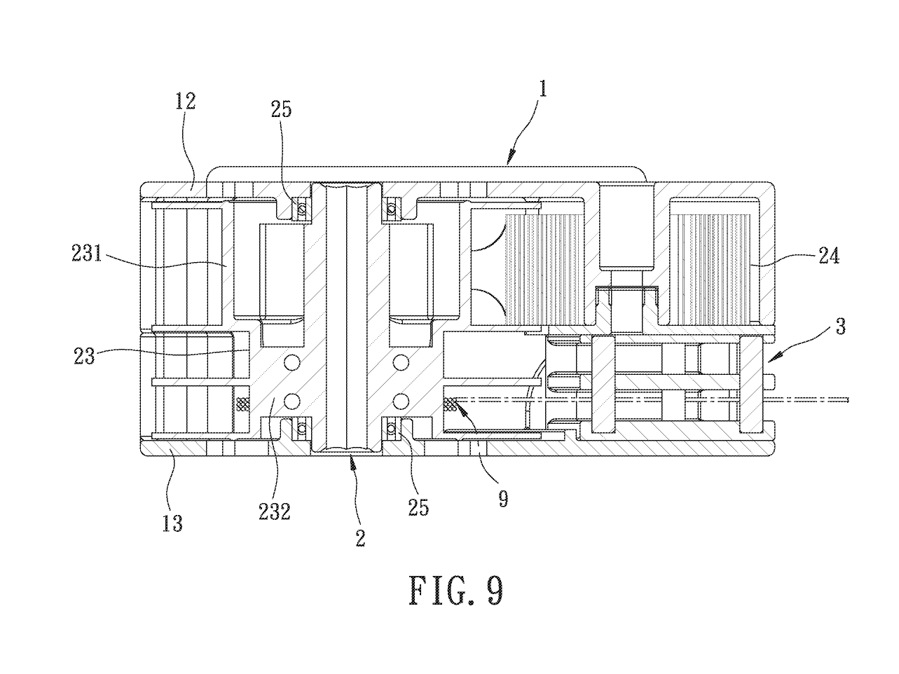

Referring to FIGS. 8 and 9, the second embodiment of the cord reel device according to the disclosure is similar to the first embodiment. The difference between the first and second embodiments resides in the reel unit 2. In this embodiment, the reel unit 2 is disposed in the retaining space 11 of the casing unit 1, and includes a reel wheel 23 that is rotatable for reeling the pull cord 9, a driving module 24 that is connected to the reel wheel 23, and two bearings 25 that are respectively connected between the first casing body 12 and the reel wheel 23 and between the second casing body 13 and the reel wheel 23. The driving module 24 is configured as a spiral spring that has two opposite ends respectively connected to the reel wheel 23 and the casing unit 1. The reel wheel 23 is disposed between the first and second casing bodies 12, 13, and has a first axle portion 231 that permits the driving module 24 to be connected thereto, and a second axle portion 232 that is connected to the first axle portion 231 and that permits the pull cord 9 to be connected thereto.

When the blind unit (not shown) is lowered, a wound portion of the pull cord 9 is drawn out from the casing unit 1 to rotate the reel wheel 23, and the driving module 24 (i.e., the spiral spring) is therefore deformed to generate a restoring force. At this time, the restoring force generated by the driving module 24 and the sum of the weight of the blind unit and the frictional force (i.e., the retarding force) generated between the pull cord 9 and the retard unit 3 are substantially equal to each other, so the blind unit is maintained at a lowered state.

When the blind unit is raised, the driving module 24 (i.e., the spiral spring) is restored to rotate the reel wheel 23, so that the pull cord 9 is wound onto the second axle portion 232 of the reel wheel 23. At this time, the weight of the blind unit and the sum of the restoring force generated by the driving module 24 and the frictional force generated between the pull cord 9 and the retard unit 3 are substantially equal to each other, so the blind unit is maintained at a raised state.

The advantages of the cord reel device according to the disclosure are as follows:

1. Since the driving module 22, 24 drives rotation of the reel wheel 21, 23 for reeling the pull cord 9, the pull cord 9 is prevented from being exposed and is operated by the cord reel device to adjust the blind unit.

2. Since the reel unit 2 and the retard unit 3 are disposed in the casing unit 1, the cord reel device has a compact structure.

In the description above, for the purposes of explanation, numerous specific details have been set forth in order to provide a thorough understanding of the embodiments. It will be apparent, however, to one skilled in the art, that one or more other embodiments may be practiced without some of these specific details It should also be appreciated that reference throughout this specification for “one embodiment”, “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A cord reel device adapted for retaining a pull cord of a window blind, comprising
a casing unit defining a retaining space therein;
a reel unit disposed in said retaining space, and including a reel wheel that is rotatable for reeling the pull cord, and a driving module that is connected to said reel wheel for driving rotation of said reel wheel; and
a retard unit including at least three retarding pins that permit the pull cord to extend therearound for providing a retarding force to the pull cord.

2. The cord reel device as claimed in claim 1, wherein said driving module includes an electric motor set, and a gear train that is connected between said reel wheel and said electric motor set for transmitting mechanical power from said electric motor set to said reel wheel.

3. The cord reel device as claimed in claim 2, wherein said reel wheel is rotatably disposed in said retaining space of said casing unit, and is rotatable about a rotating axis that extends in a first direction, said reel wheel having at least one through hole that permits the pull cord to extend therethrough so as to be positioned and that substantially extends in an extending direction perpendicular to the first direction.

4. The cord reel device as claimed in claim 3, wherein said casing unit includes a first casing body, and a second casing body that is connected to said first casing body and that cooperates with said first casing body to define said retaining space, said second casing body having an installation groove that forms a portion of said retaining space, said retard unit further including a base seat that is removably mounted in said installation groove.

5. The cord reel device as claimed in claim 3, wherein each of said retarding pins substantially extends in the first direction.

6. The cord reel device as claimed in claim 4, wherein said base seat of said retard unit includes three compartment plates that are spaced apart from each other in the first direction, and two side plates that are respectively connected to two opposite sides of each of said compartment plates, each of said compartment plates being formed with a plurality of installation holes that are respectively aligned with said installation holes of another one of said compartment plates in the first direction, each of said retarding pins being inserted into one of said installation holes of one of said compartment plates and the aligned. installation holes of the other compartment plates.

7. The cord reel device as claimed in claim 6, wherein said side plates of said base seat are movable in a second direction perpendicular to the first direction to be removably fitted into said installation groove.

8. The cord reel device as claimed in claim 6, wherein said reel wheel has an axle portion that extends in the first direction, a reel portion that surrounds said axle portion, a partition plate that divides said reel portion into a first reel region and a second reel region, and two securing structures that are respectively disposed at said first and second reel regions for securing the pull cord to said reel wheel, each of said securing structures including two of said through holes that are formed through the corresponding one of said first and second reel regions, the middle one of said compartment plates being substantially aligned with said partition plate of said reel wheel in a second direction perpendicular to the first direction, and dividing each of said retarding pins into a first retarding section and a second retarding section, said first and second retarding sections of each of said retarding pins respectively corresponding to said first and second reel regions of said reel wheel.

9. The cord reel device as claimed in claim 2, wherein said electric motor set includes an electric motor that is connected to said gear train, and a battery for supplying electric power to said electric motor.

10. The cord reel device as claimed in claim 1, wherein. said driving module is configured as a spiral spring that has two opposite ends respectively connected to said reel wheel and said casing unit.

11. The cord reel device as claimed in claim 1, the window blind further including an upper rail that permits the pull cord to extend therethrough and that has an installation space, wherein said casing unit is movable in a second direction perpendicular to the first direction to be inserted into the installation space of the upper rail.

12. The cord reel device as claimed in claim 11, the upper rail having two spaced-apart side walls that extend in the second direction, and that cooperatively define the installation space therebetween, wherein said casing unit further has two lateral stop walls that respectively abut against the side walls of the upper rail.

13. The cord reel device as claim 11, wherein said casing unit further has an end stop wall that is opposite to said installation groove and that abuts against the side walls of the upper rail.
